(19) United States
(12) Patent Application Publication
(10) Pub. No.: US 2015/0087282 A1
(43) Pub. Date: Mar. 26, 2015

(54) AUTO-SETTING SILENT/VIBRATE MODE FOR CALL RECEPTION ON A MOBILE PHONE DEVICE

(71) Applicant: SURENDRA PRAJAPAT, CUPERTINO, CA (US)

(72) Inventor: SURENDRA PRAJAPAT, CUPERTINO, CA (US)

(21) Appl. No.: 14/310,894

(22) Filed: Jun. 20, 2014

Related U.S. Application Data
(60) Provisional application No. 61/880,851, filed on Sep. 21, 2013.

(51) Int. Cl. H04M 1/725

(52) U.S. Cl. CPC H04M 1/72569
USPC 455/418

(57) ABSTRACT

A system and method to auto-set a mobile phone device in silent or vibrate mode. The system and method may include an audio sensing component and a video sensing component of the phone environment, and a software application/service module for detecting and gathering data of a user's current surroundings or environment. The software application/service module may be configured to automatically set the mobile phone in silent or vibrate mode based on the user's current surroundings analysis and captured audio and video data.

### RELATED APPLICATIONS

This application claims the benefit of priority of U.S. Provisional Application Ser. No. 61/880,851 filed Sep. 21, 2013, which is hereby incorporated by reference in its entirety.

### BACKGROUND

This document generally relates to software applications “apps” for electronic devices, and more specifically, for mobile devices having advanced computing capabilities such as smartphones, personal digital assistants (PDAs), and tablets.

The advanced computing capabilities of mobile devices have provided many useful, convenient and sometime essential applications in everyday life. Categories of “apps” include, for example, entertainment/gaming apps, finance apps, tools/utilities apps, medical apps, and many more.

Mobile phone devices may benefit from smart application and can be essential and desirable especially when it involves interaction with the surroundings and environment.

### SUMMARY

It is an advantage of the present invention to provide a system and method to auto-set a mobile phone device in silent or vibrate mode.

It is another advantage of the present invention to provide a software application/service module for detecting and gathering data of a user's current surroundings or environment.

It is yet another advantage of the present invention to provide a capture data by an audio sensing component and a video sensing component of the phone environment.

It is no less another advantage of the present invention to provide analysis of the captured audio and video data by the software application/service module which automatically sets the mobile phone in silent or vibrate mode based on the user's current surroundings.

An additional advantage of the present invention provides a software application/service module that may send a notification to an incoming caller based on the state of the mobile phone device.

Another advantage of the present invention provides a cloud service to assist in auto-setting the mobile phone device.

These and other objects, features and advantages of the present invention will become more apparent in light of the following detailed description of preferred embodiments thereof, as illustrated in the accompanying drawings.

### BRIEF DESCRIPTION OF THE DRAWINGS

The present invention will be more clearly understood from the following detailed description of the preferred embodiments of the invention and from the attached drawings, in which:

FIG. 1 illustrates an auto-silent/vibrate mode application operating on a mobile phone device, in accordance with an embodiment of the present invention;

FIG. 2 illustrates a block diagram of a mobile device utilizing a cloud service to assist in the auto-silent/vibrate mode, in accordance with an embodiment of the present invention.

### DETAILED DESCRIPTION

Although mobile phone devices provide users many features and advantages, it also can be a source of distraction or annoyance to others within the same vicinity. This includes, for example, situations where the mobile device rings in movie theaters, conferences, presentations, lecture halls, church, or hospitals and where the user forgets to set their mobile phone device in silent mode. In this situation, a method and system capable of automatically setting the phone in silent or vibrate mode can be beneficial and advantageous to many users.

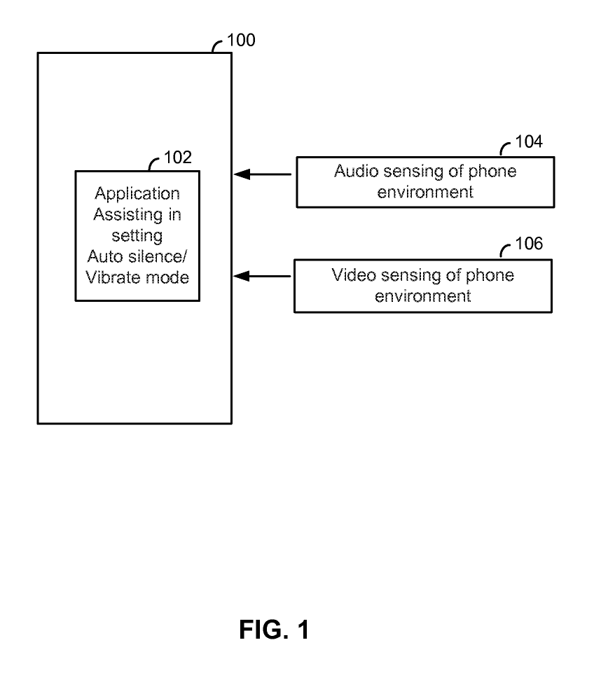

FIG. 1 illustrates a method and system to auto-set a mobile phone device 100 in silent or vibrate mode, including haptic or tactile feedback mechanisms. In this illustration, a software application module or service module 102 may be installed and executed on the mobile phone device 100. The software application module or service module 102 includes algorithms for detecting and gathering data of the user's current surroundings or environment by utilizing audio and video capabilities of the mobile phone device 100. Data captured by an audio sensing component 104 and a video sensing component 106 of the phone environment may be fed as input to the mobile phone device 100. The captured audio and video data are analyzed by the software application module or service module 102 which may automatically set the mobile phone 100 in silent or vibrate mode based on the user's current surroundings. The mobile phone device 100 may also include configuration settings to disable or enable the software application module or service module 102.

In one embodiment of the present invention, the mobile phone device 100 of FIG. 1 may be provided with circuitry and hardware components capable of capturing video or images and recording audio. Such hardware components include, for example, a video camera and a microphone. The captured video and audio recording may be analyzed by the software application module or service module 102 using object recognition and sound recognition algorithms to identify and classify objects and sounds. Based on the identified objects and sounds, the software application module or service module 102 may utilize a database to determine the user's current surroundings and set the state of the mobile phone device 100 based the user's current surroundings. For example, when user is outside, images and sounds of cars, trucks, airplanes, people, crowds, and animals, may be captured and analyzed by the mobile phone device 100 to trigger the phone to enable the ringer. In contrast, when the user is an inside environment such as a movie theaters, conferences, presentations, lecture halls or hospitals, images of interior lighting, furniture, desks, or walls may be captured and analyzed by the mobile phone device 100 to trigger the phone to a silent state.

In another embodiment, the software application module or service module 102 can optionally send a notification to an incoming caller based on the state of the mobile phone device 100. For example, if the caller is calling the mobile phone device 100 when the phone is in vibrate mode, the service/application module 102 may send the notification to the caller indicating the current status of the mobile phone user. This notification can includes but not limited to a text message, email, text-to-speech voice mail, or in-call feedback.

In yet another embodiment, the service/application module 102 may also display a visual feedback to the mobile phone user indicating that the service/application module 102 is enabled or disabled. Examples of visual feedback include but are not limited to static/flashing icons, pop-up images, or animated icons. If enabled, service/application module 102 may also indicate to the mobile phone user that phone has been set to a silent/vibrate mode automatically. The user may modify configuration settings of the mobile phone device 100 to override any actions which are automatically controlled by the service/application module 102.

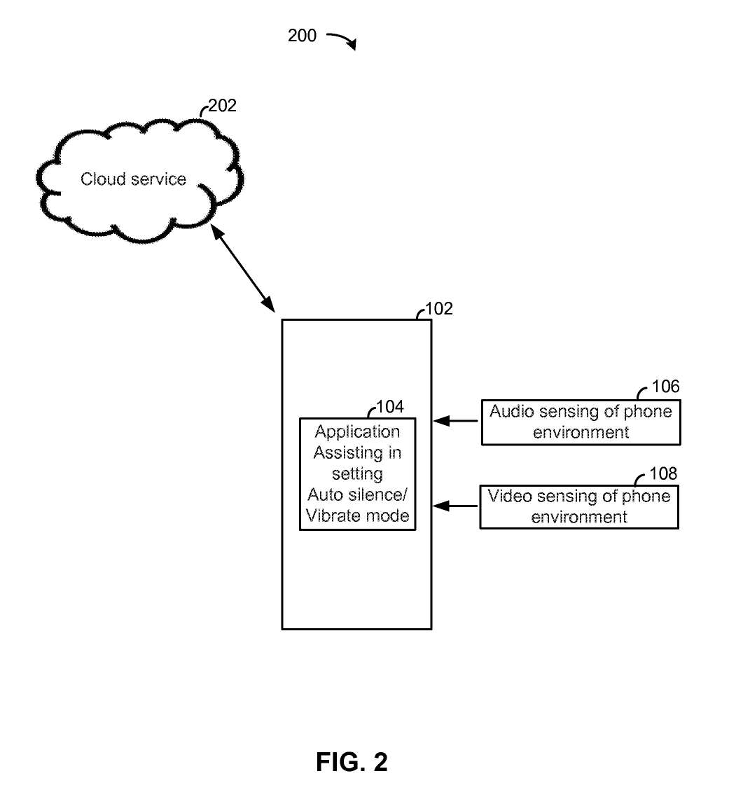

FIG. 2 illustrates another embodiment of the method and system to auto-set the mobile phone device 100 in silent or vibrate mode. In this illustration, a cloud service 202 in a remote location provides application and service support and updates to the service/application module 102 of the mobile phone device 100. The cloud service 202 may include multiple remote servers connected through a communication network such as an intranet, the Internet, a local area network (LAN) or wide area network (WAN).

In yet another embodiment, sensing data is acquired on the phone device 100 such that processing and decision by a processing module and decision-making module, respectively, for identifying the environment is performed by the service/application module 102 running in the cloud service 202. Decision may be sent to the phone device 100 to take appropriate actions. The cloud service 202 may be shared among other mobile devices such as, for example, tablets, laptops, smartphones, and smart watches. The decision learned may be based on multiple inputs from one or more other mobile devices and can be cataloged to arrive to similar decision for another device based on the similarity of inputs.

As used in the specification and the appended claims, the singular forms “a”, “an”, and “the” included plural referents unless the context clearly dictates otherwise.

All patents, patent applications, and other references cited herein are incorporated by reference in their entireties.

It is noted that the foregoing disclosure has been provided merely for the purpose of explanation and is in no way to be construed as limiting of the present invention. Although the present invention has been shown and described with respect to several preferred embodiments thereof, various changes, omissions, and additions to the form and detail thereof, may be made therein, without departing from the spirit and scope of the invention. It is understood that the words which have been used herein are words of description and illustration, rather than words of limitation. Changes may be made, within the purview of the appended claims, as presently stated and as amended, without departing from the scope and spirit of the present invention in its aspects.

Other embodiments and modifications of the present invention may occur to those of ordinary skill in the art in view of these teachings. Accordingly, the invention is to be limited only by the following claims which include all other such embodiments and modifications when viewed in conjunction with the above specifications and accompanying drawings.

What is claimed is what is described and illustrated, including:

1. A system comprising:
a mobile device, wherein the mobile device is configured to generate an audio notification or a haptic feedback notification based on a mode setting of the mobile device;
an audio sensor for detecting and capturing sounds of an environment proximate to the mobile device;
a video sensor for detecting and capturing a plurality of images the environment proximate to the mobile device; and
a software module configured to generate analyzed data from the sounds captured by the audio sensor and the plurality of images captured by the video sensor, wherein the software module determines the environment of the mobile phone device based on the analyzed data and automatically sets the mode setting of the mobile device based on the environment.

2. The system of claim 1 wherein the software module disables the audio notification and the haptic feedback notification when the environment of the mobile device is determined to be in a pre-defined quiet location.

3. The system of claim 2 wherein the pre-defined quiet location is defined to be a movie theater, a classroom, a lecture hall, a meeting, a church, or a conference room.

4. The system of claim 1 wherein the software module enables the audio notification and haptic feedback notification when the environment of the mobile device is determined to be in a pre-defined public location.

5. The system of claim 1 wherein the mobile device is a mobile phone, a smartphone, a tablet, a laptop computer, or a smart watch.

6. The system of claim 1 wherein the audio sensor is a microphone.

7. The system of claim 1 wherein the video sensor is a video camera.

8. The system of claim 1 wherein the software module is an application module or service module.

9. The system of claim 1, wherein the software module further comprises a database for storage of data relating to the pre-defined quiet locations and the pre-defined public location.

10. A system comprising:
a mobile device, wherein the mobile device is configured to generate an audio notification or a haptic feedback notification based on a mode setting of the mobile device;
an audio sensor for detecting and capturing sounds of an environment proximate to the mobile device;
a video sensor for detecting and capturing a plurality of images the environment proximate to the mobile device;
a software module configured to generate analyzed data from the sounds captured by the audio sensor and plurality of images captured by the video sensor, wherein the software module determines the environment of the mobile phone device based on the analyzed data and automatically sets the mode setting of the mobile device based on the environment; and
a remote service coupled to the mobile device to support the mode setting of the software module.

11. The system of claim 10 wherein the analyzed data is acquired on the mobile device.

12. The system of claim 11, wherein the software module further comprises a data processing module and a decision-making module.

13. The system of claim 12 wherein the data processing module and decision-making module for identifying the environment are performed by the software module running in the remote service.

14. The system of claim 13 wherein the decision-making module transmits operating instructions to the mobile device to automatically set the mode setting of the mobile device based on the environment.

15. The system of claim 14 wherein the remote service is shared among a plurality of devices.
